(19) United States
(12) Patent Application Publication
(10) Pub. No.: US 2026/0117955 A1
(43) Pub. Date: Apr. 30, 2026

(54) CONNECTORS FOR LIGHT FIXTURES AND METHOD OF INSTALLING THE SAME

(71) Applicant: Nulite Lighting, Inc., Denver, CO (US)

(72) Inventors: Jack Davies, Denver, CO (US); Mark Guminski, Lakewood, CO (US); Aaron Helgerson, Denver, CO (US)

(73) Assignee: Nulite Lighting, Inc., Denver, CO (US)

(21) Appl. No.: 19/370,159

(22) Filed: Oct. 27, 2025

Related U.S. Application Data
(60) Provisional application No. 63/713,160, filed on Oct. 29, 2024.

(51) Int. Cl. F21V 15/01

(52) U.S. Cl. CPC F21V 15/01

(57) ABSTRACT

A light fixture includes a first housing and a second housing. A male connector extends from one end of the first or second housing and has an outer surface defining at least one groove or rib substantially parallel to the housing end. A female connector is defined in the other end of the first or second housing. The female connector has an inner surface defining the other of the at least one groove or rib substantially parallel to the housing end. When the male connector is received by the female connector, the at least one rib slidingly engages at least partially within the at least one groove such that the outer surface of the male connector overlaps and is directly adjacent the inner surface of the female connector coupling the ends of the first housing and the second housing.

### CROSS-REFERENCE TO RELATED APPLICATION(S)

This application claims priority to, and the benefit of, U.S. Provisional Patent Application No. 63/713,160, filed Oct. 29, 2024, the disclosure of which is incorporated herein by reference in its entirety.

### BACKGROUND

At least some known light fixtures are configured for use in architectural spaces. For example, light fixtures may be standalone luminaries, elongated in long continuous linear or curved runs, or form unique configurations (e.g., shapes or patterns). These light fixtures can be recessed, or surface mounted on walls or ceilings, the light fixtures can also be suspended as a pendent from ceilings. The light fixtures can also be wet rated and sealed for outdoor use. Furthermore, light distribution from the light fixtures can also be tailored for the architectural space, such as direct, asymmetric, bi-direct, indirect, and up-light light distribution patterns. In these examples, the light fixtures may include modular housing components that are selectively coupled together to form the lighting system. It is desirable that when housing components are coupled together, the connection joint supports pull down forces that meet building codes, that the connection joint be easily connectable for installers working at ceiling heights, and that the connection joint shield light beams from the joint seam. Accordingly, improvements to connectors for light fixtures are desired.

### SUMMARY

This disclosure relates generally to architectural light systems, and in particular, connection systems for light fixtures.

In an aspect, the technology relates to a light fixture including: a first housing configured to support a first light source and having a first end; a second housing configured to support a second light source and having a second end; a male connector extending from one of the first or second end and corresponding in shape to an inner perimeter profile of the one of the first or second end of the first or second housing, the male connector having an outer surface defining at least one groove or rib substantially parallel to the one of the first or second end; and a female connector defined in the other of the first or second end, the female connector having an inner surface defining the other of the at least one groove or rib substantially parallel to the other of the first or second end, wherein when the male connector is received by the female connector, the at least one rib slidingly engages at least partially within the at least one groove such that the outer surface of the male connector overlaps and is directly adjacent the inner surface of the female connector coupling the first end of the first housing to the second end of the second housing.

In an example, the at least one groove and the at least one rib include corresponding detents. In another example, the male connector has a substantially U-shaped body, the at least one groove or rib disposed on all three sides of the outer surface of the substantially U-shaped body. In still another example, the detents are disposed on opposing side members of the substantially U-shaped body. In yet another example, the male connector defines a longitudinal axis, the female connector transversely slidable relative to the longitudinal axis to engage the male connector. In an example, the male connector defines a longitudinal axis, the male connector axially extending from the one of the first or second end of the first or second housing a distance that is at least three times greater than an axial width of the at least one groove or rib.

In another example, the male connector includes the at least one groove disposed proximate an end of the male connector, the end of the male connector including a reduced outer profile section configured to allow a portion of the at least one rib of the female connector to axially slide relative to the end of the male connector so as to at least partially receive the at least one rib within the at least one groove. In still another example, the male connector is a discrete component and is coupled to the first or second end of the first or second housing.

In another aspect, the technology relates to a light fixture including: two or more housings configured to support a light source, a first housing and a second housing of the two or more housings each having a first end and a second end, the first end and the second end defining a female connector having an inner surface including at least one rib substantially parallel to the first end and the second end; and at least one male connector having a body corresponding in shape to an inner perimeter profile of the two or more housings with a first end and an opposite second end defining a longitudinal axis, the first end and the second end of the body symmetrical relative to the longitudinal axis and the first end and the second end of the body having an outer surface defining at least one groove extending orthogonal to the longitudinal axis, wherein the at least one male connector is configured to couple the first housing and the second housing together along the longitudinal axis such that an outer perimeter profile of the two or more housings align, and wherein when the first end of the body is received by the second end of the first housing, the at least one rib of the second end of the first housing slidingly engages at least partially within the at least one groove of the first end of the body such that the outer surface of the first end of the body overlaps and is directly adjacent the inner surface of the second end of the first housing, and when the second end of the body is received by the first end of the second housing, the at least one rib of the first end of the second housing slidingly engages at least at least partially within the at least one groove of the second end of the body such that the outer surface of the second end of the body overlaps and is directly adjacent the inner surface of the first end of the second housing.

In an example, the at least one groove and the at least one rib include corresponding detents. In another example, the at least one male connector includes at least one spring pin extending from the first end of the body, the at least one spring pin engaging an inner extrusion profile feature of the first housing. In still another example, the at least one spring pin does not engage with the second housing. In yet another example, the light fixture further includes an end cap, the end cap including a second male connector having an outer surface defining at least one groove extending orthogonal to the longitudinal axis, wherein when the second male connector is received by the first end of the first housing, the at least one rib of the first end of the first housing slidingly engages at least partially within the at least one groove of the second male connector such that the outer surface of the second male connector overlaps and is directly adjacent the inner surface of the first end of the first housing. In an example, at least one of the first end or second end of the body includes an axial recess disposed partially around the outer surface, the axial recess in communication with the at least one groove such that at least a portion of the at least one rib of the female connector is configured to axially slide along the longitudinal axis through the axial recess when being received within the at least one groove.

In another example, the second end of the first housing and the first end of the second housing abut each other at a joint disposed at a longitudinal midpoint of the at least one male connector, the male at least one connector extending completely around the joint at the inner surface. In still another example, the light fixture further includes a substrate having the light source, wherein the substrate is disposed within the first housing and elongated along the longitudinal axis, the substrate extending at least partially within the at least one male connector.

In another aspect, the technology relates to a method of installing a light fixture, the method including: providing two or more housings configured to support a light source, a first housing and a second housing of the two or more housings each having a first end and a second end, the first end and the second end defining a female connector having an inner surface including at least one rib substantially parallel to the first end and the second end; attaching a male connector to the second end of the first housing, the male connector having a body corresponding in shape to an inner perimeter profile of the two or more housings with a first end and an opposite second end defining a longitudinal axis, the first end and the second end of the body symmetrical relative to the longitudinal axis and the first end and the second end of the body having an outer surface defining at least one groove extending orthogonal to the longitudinal axis, wherein when the first end of the body is received by the second end of the first housing, the at least one rib of the second end of the first housing slidingly engages at least partially within the at least one groove of the first end of the body such that the outer surface of the first end of the body overlaps and is directly adjacent the inner surface of the second end of the first housing; and coupling the first end of the second housing to the male connector such that the first housing and the second housing abut each other at a joint, wherein when the second end of the body is received by the first end of the second housing, the at least one rib of the first end of the second housing slidingly engages at least at least partially within the at least one groove of the second end of the body such that the outer surface of the second end of the body overlaps and is directly adjacent the inner surface of the first end of the second housing.

In an example, the method further includes securing the male connector to the second end of the first housing via engaging at least one spring pin with an inner extrusion profile feature of the first housing. In another example, the sliding engagement of the first housing and the second housing occurs in an orthogonal transverse direction relative to the longitudinal axis. In still another example, coupling the first end of the second housing to the male connector includes axially sliding the first end of the second housing at least partially into the male connector.

A variety of additional aspects will be set forth in the description that follows. The aspects can relate to individual features and to combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 is a side view of an exemplary light fixture according to an embodiment of this disclosure.

FIG. 2 is an end view of the light fixture shown in FIG. 1.

FIG. 3 is another end view of the light fixture shown in FIG. 1.

FIG. 4 is a cross-section view of the light fixture shown in FIG. 1.

FIGS. 5 and 6 are perspective views of an end of the housing shown in FIG. 4.

FIGS. 7 and 8 are perspective views of a male connector for use with the light fixture shown in FIG. 1.

FIGS. 9-11 are perspective views of two housings being coupled together via the male connector.

FIG. 12 is a partial, perspective, longitudinal cross-section view of the light fixture 100.

FIG. 13 is a partial, perspective, transverse cross-section view of the light fixture 100.

FIGS. 14-15 are perspective views of an end cap of the light fixture shown in FIG. 1.

FIG. 16 is an end view of another exemplary male connector for use with the light fixture shown in FIG. 1.

FIG. 17 is a flowchart illustrating an exemplary method of installing a light fixture.

### DETAILED DESCRIPTION

The figures and descriptions provided herein may have been simplified to illustrate aspects that are relevant for a clear understanding of the herein described devices, systems, and methods, while eliminating, for the purpose of clarity, other aspects that may be found in typical devices, systems, and methods. Those of ordinary skill may recognize that other elements and/or operations may be desirable and/or necessary to implement the devices, systems, and methods described herein. Because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

References in the specification to “one embodiment,” “an embodiment,” “an illustrative embodiment,” “an example,” “an aspect,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other examples whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C). Moreover, one having skill in the art will understand the degree to which terms such as “about,” “approximately,” or “substantially” convey in light of the measurement techniques utilized herein. To the extent such terms may not be clearly defined or understood by one having skill in the art, the term “about,” “approximately,” or “substantially” shall mean plus or minus ten percent.

In the drawings, some structural or method features may be shown in specific arrangements and/or orderings. However, it should be appreciated that such specific arrangements and/or orderings may not be required. Rather, in some examples, such features may be arranged in a different manner and/or order than shown in the illustrative figures. Additionally, the inclusion of a structural or method feature in a particular figure is not meant to imply that such feature is required in all examples and, in some examples, may not be included or may be combined with other features.

Throughout this description, references to orientation (e.g., front (ward), rear (ward), top, bottom, back, right, left, upper, lower, etc.) of the components of the light fixture relate to their position when installed in an architectural space and are used for ease of description and illustration only. No restriction is intended by use of the terms regardless of how the components of the light fixture are situated on its own. As used herein, the terms “axial” and “longitudinal” refer to directions and orientations, which extend substantially parallel to a centerline of the component or system. Moreover, the terms “radial” and “radially” refer to directions and orientations, which extend substantially perpendicular to the centerline of the component or system. In addition, as used herein, the term “circumferential” and “circumferentially” refer to directions and orientations, which extend arcuately about the centerline of the component or system.

In the examples described below, a light fixture is provided. The light fixture includes a plurality of housings configured to support a light system. Each housing has an end that is formed with a female connector. A discrete male connector is used to attach to one end of the housing to form a male connector on the housing and so as to couple two housings together. The male connector overlaps a portion of the inner surface of the two housings at the connection joint. This overlap increases connection strength, facilitates instillation at heights, and reduces or prevents light from escaping the connection joint. The male connector also facilitates the light fixture being able to have any number of architectural shapes and styles with the same sliding connection engagement.

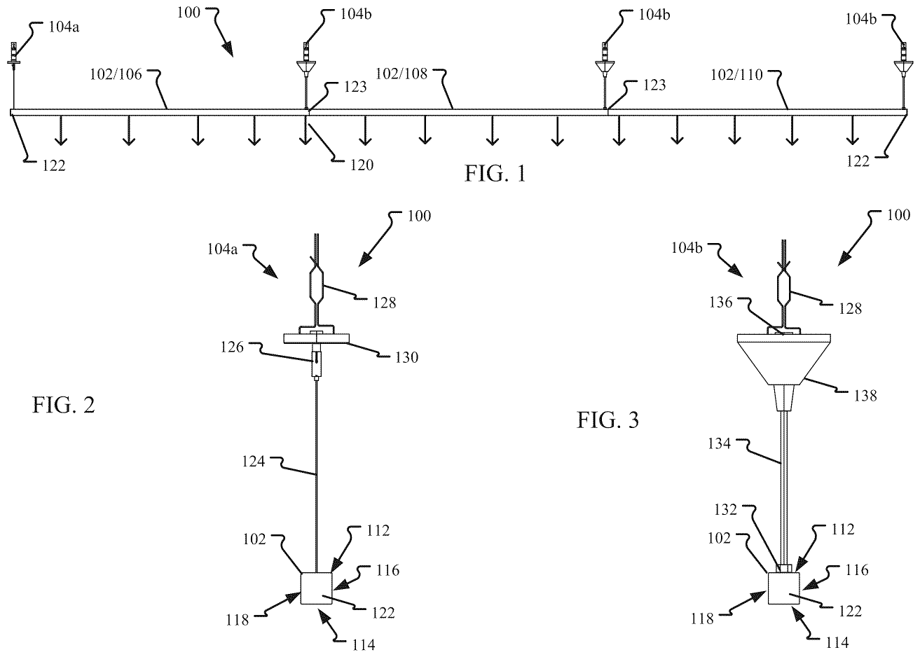

FIG. 1 is a side view of an exemplary light fixture 100. The light fixture 100 includes a plurality of modular light housings 102 that are configured to be supported from a ceiling (not shown) via one or more pendent assemblies 104. In the example, the housings 102 include a first housing 106, a second housing 108, and a third housing 110 coupled together in a linear formation and with all of the housings 102 at the same horizontal elevation. It is appreciated, that the light fixture 100 may include any number of modular housings 102 as required or desired (e.g., one, two, four, or five or more). Further, it is appreciated, that the light fixture 100 may have any shape or pattern as required or desired. For example, the light fixture 100 may form, but is not limited to, an elongated curved configuration such as a C-shape, a S-shape, etc., a shape with linear portions (e.g., a square, a rectangle, a triangle, a X-shape, a T-shape, a Y-shape, etc.), a shape with curved portions (e.g., a circle, an oval, etc.), a shape with linear and curved portions (e.g., a U-shape), or a shape having housings at different horizontal elevations.

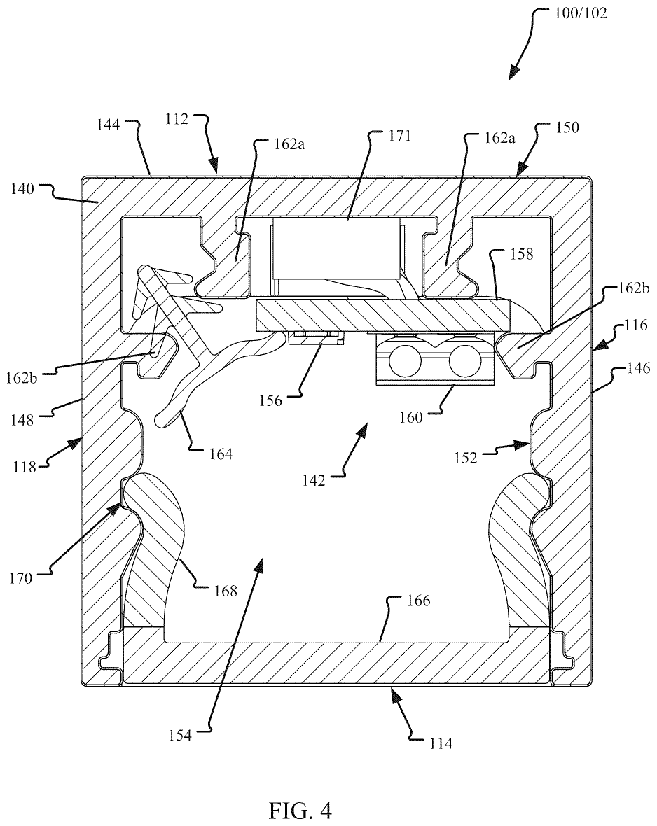

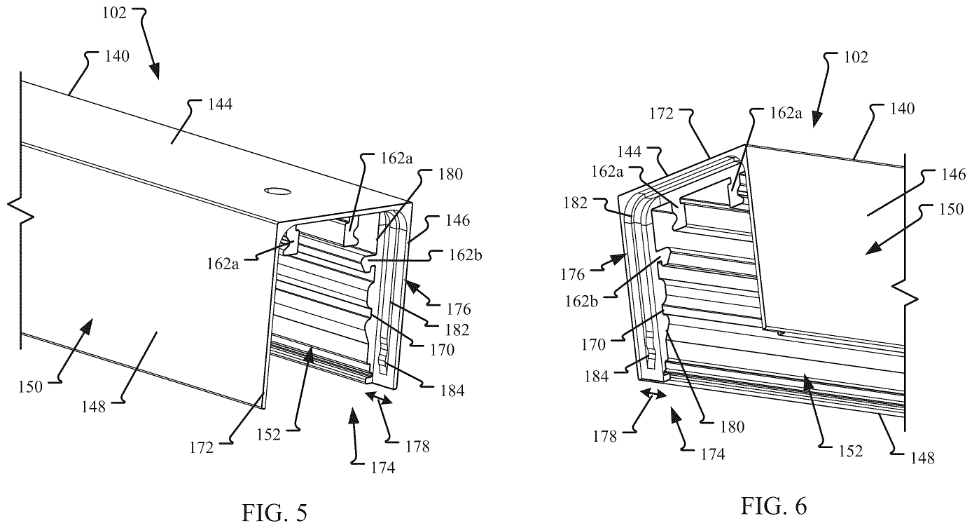

Each housing 102 generally has a top 112, a bottom 114, a right side 116, and a left side 118 (shown in FIGS. 2 and 3). In this example, the bottom 114 of the housing 102 is configured to facilitate light distribution 120 from the light fixture 100 and from all of the housings 102. The pendent assemblies 104 are coupled to the top 112 of the housings 102. At each end of the housings 106, 110, an end cap 122 is attached.

To form the light fixture 100, the ends of each housing 106, 108, 110 are coupled together at a joint 123. In the example, the joint 123 is configured to maintain the outer perimeter profile shape of each housing 102 while also providing sufficient structural strength to meet or exceed building codes. Furthermore, the joint 123 is also configured to enable the light system within the housings 102 to extend through each housing 106, 108, 110 as required or desired.

FIG. 2 is an end view of the light fixture 100 with pendent assembly 104a. FIG. 3 is another end view of the light fixture 100 with pendent assembly 104b. Referring concurrently to FIGS. 2 and 3, the light fixture 100 illustrates two different configurations of the pendent assembly 104a, 104b. It is appreciated, that other pendent assembly configurations may be used as required or desired and that typically a lighting fixture includes only a single type of pendent configuration based on the desired aesthetics.

Starting with FIG. 2, the pendent assembly 104a includes a vertical cable 124 with a bottom end coupled to the top 112 of the housing 102. In the example, the bottom end of the vertical cable 124 includes an enlarged bulb that is retained underneath a top opening that the cable 124 extends through. A top end of the cable 124 is coupled to a cable mount 126 that extends downward from a mounting bracket 128 configured to secure to a structural ceiling member. A decorative escutcheon 130 may couple to the cable mount 126. In pendent assembly 104a, electrical wiring (not shown) may extend down the vertical cable 124 adjacent the exterior and enter the housings 102 at the top opening.

Turning next to FIG. 3, the pendent assembly 104b includes a coupling 132 that is configured to couple the housing 102 to a multi conductor cable 134. In some examples, the multi conductor cable 134 is configured to facilitate electrical wiring to be extended from the supporting structure (e.g., ceiling) and into the housing 102. At a top end of the multi conductor cable 134, the muti conductor cable 134 is coupled to a cable mount 136 that extends downward from the mounting bracket 128. One or more decorative escutcheons 138 may couple around the cable mount 136.

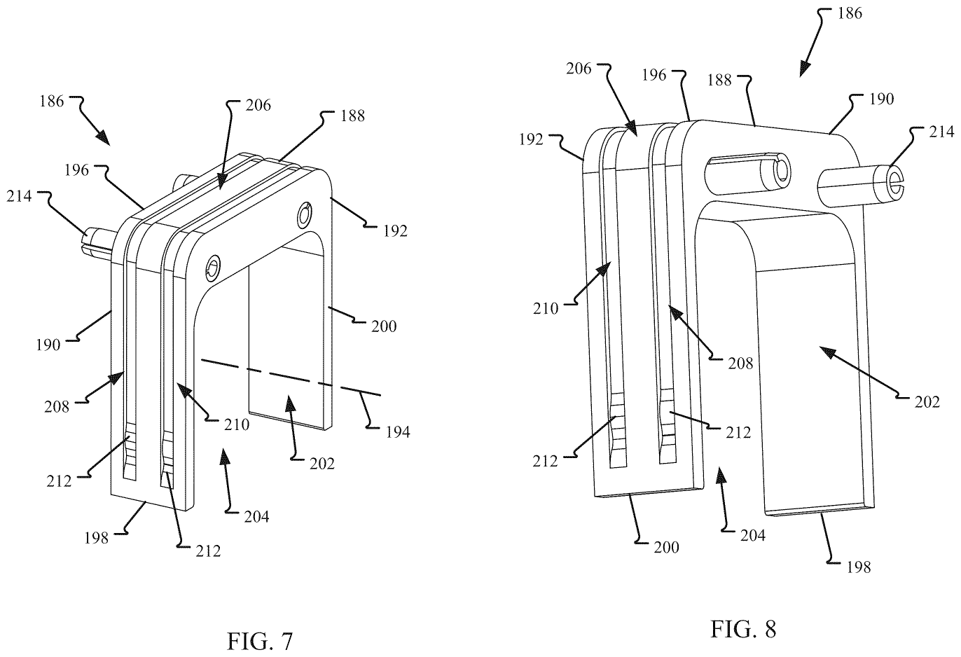

FIG. 4 is a cross-section view of the light fixture 100 at the housing 102. In the example, each housing 102 is formed from an elongate body 140 configured to support a light system 142 therein. The elongate body 140 has a U-shape with a top wall 144 forming the top 112 of the housing 102, and a pair of sidewalls 146, 148 forming the right and left sides 116, 118 of the housing 102. The elongate body 140 has an outer surface 150 that defines the architectural shape of the housing 102, and in the illustrated example, forms a substantially square outer perimeter profile shape. In other examples, the outer perimeter profile shape of the body 140 may take on any other shape as required or desired (e.g., rectangular, polygonal, circular, or oval shapes). An inner surface 152 at least partially defines an interior cavity 154 of the body 140 that is shaped and sized to receive the light system 142. The inner surface 152 at least partially defines an inner perimeter profile of the housing 102 that is substantially U-shaped and matching the outer perimeter profile shape. In other aspects, the inner and outer perimeter profiles may have different shapes.

The inner surface 152 may be formed with one or more interior members (e.g., 162, 170) that are configured to support components of the light system 142. In the example, the cross-sectional shape of the elongate body 140 enables the elongate body 140 to be formed via an extrusion manufacturing process. As such, a longitudinal length of the body 140 can be defined as required or desired for the light fixture 100. Additionally, the elongation of the body 140 may be linear (as depicted) or have a curvature as required or desired.

The light system 142 includes a plurality of light emitting diodes (LEDs) 156 disposed on a LED substrate 158. The LED substrate 158 also includes one or more electrical wire connectors 160. The inner surface 152 of the body 140 includes a plurality of inner arm extensions 162 (e.g., two 162a extending from the top wall 144 and one 162b extending from each of the sidewalls 146, 148 proximate the top wall 144). The LED substrate 158 is supported between two adjacent inner arm extensions 162a,b and held in place with a LED cover 164 that engages the other two adjacent inner arm extensions 162a,b. In some examples, the LED cover 164 may act as a reflector for the light emitted from the LEDs 156. The light system 142 also includes a lens cover 166 that forms the bottom 114 of the housing 102 and that enables light to be emitted from the housing 102. In the example, the lens cover 166 includes snap arms 168 that engage with inner recesses 170 formed on the inner surface 152 of the body 140 in a snap fit or press fit engagement. The light system 142 may include a spacer 171 disposed between the inner arm extensions 162a and above the LED substrate 158. One of skill in the art will appreciate that other light system configurations may additionally or alternatively be supported within the housing 102 as required or desired.

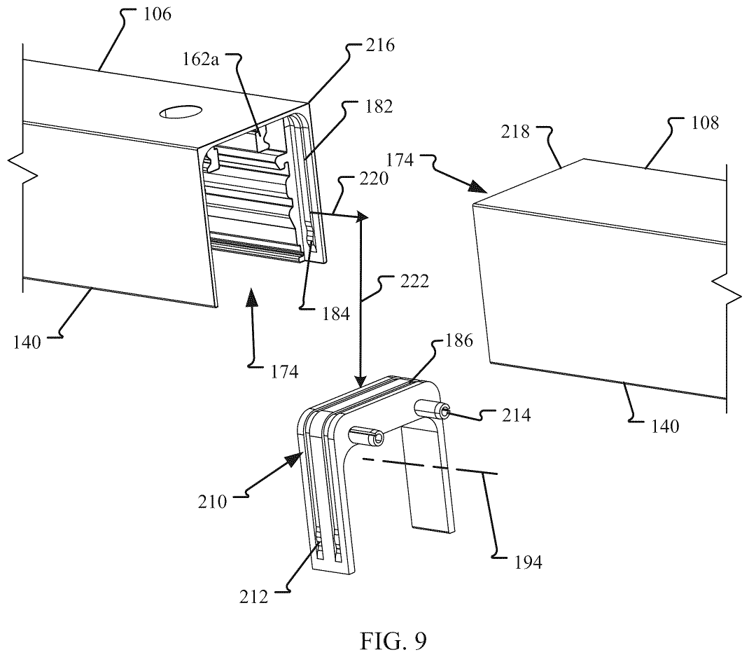

FIGS. 5 and 6 are perspective views of an end 172 of the body 140 of the housing 102. Referring concurrently to FIGS. 5 and 6, the end 172 of the body 140 includes a female connector 174 that is integrally formed within the body 140 and defined only on the inner surface 152 such that the outer surface 150 of the body 140 is uniform throughout the length of the body 140. The female connector 174 is formed as a radial cutout 176 of the interior members (e.g., the arm extensions 162 and the inner recesses 170) of the inner surface 152 of the body 140 such that the interior members are separated from the end 172 of the body 140. In an aspect, after the body 140 is formed via the extrusion process, the end 172 of the body 140 is further machined in a different manufacturing step so as to form the female connector 174 within the inner surface 152.

In the example, the radial cutout 176 extends axially inward for a distance 178 from the end 172 of the body 140. The radial cutout 176 also extends around the entire inner perimeter of the body 140 and along the top wall 144 and the right and left sidewalls 146, 148. The radial cutout 176 has a thickness (defined between the outer surface 150 and the inner surface 152 of the body 140) that is smaller than a thickness of the body 140 at the interior members so that an axial wall 180 is formed within the inner surface 152 of the body 140 and defining an inward most end of the radial cutout 176 and at the axial distance 178 from the end 172. The radial cutout 176 of the female connector 174 is configured to overlap a male connector component that is described further below and form the joint 123 (shown in FIG. 1) between two adjacent and connected housings 102.

At least one rib 182 is formed on the inner surface 152 of the radial cutout 176. In the example, the rib 182 extends along all three sides of the inner surface 152 of the radial cutout 176 and along the top wall 144 and the right and left sidewalls 146, 148 so that the rib 182 is oriented substantially parallel to the end 172 of the body 140 and the plane defined by the end face. In an aspect, the rib 182 is centered on the radial cutout 176 and relative to the axial distance 178. The rib 182 is configured to be received within a corresponding groove of the male connector when the female connector 174 is engaged thereto. One or both of the ends of the rib 182 may include a detent 184. The detents 184 are disposed on opposing sidewalls 146, 148 of the U-shaped body 140 of the housing 102. In the example, the detent 184 includes an initial ramp surface and an adjacent cavity. The detent 184 is configured to engage with a corresponding detent feature on the male connector to snap fit the male connector to the female connector 174 when the male connector is received therein. In other examples, the inner surface 152 of the radial cutout 176 may include a groove instead of the rib. In still further examples, the female connector 174 may be formed as a discrete component, and for example, a U-shaped body having an interior surface that forms the female connection components, and an outer surface configured to couple to the interior members of the extruded elongate body 140.

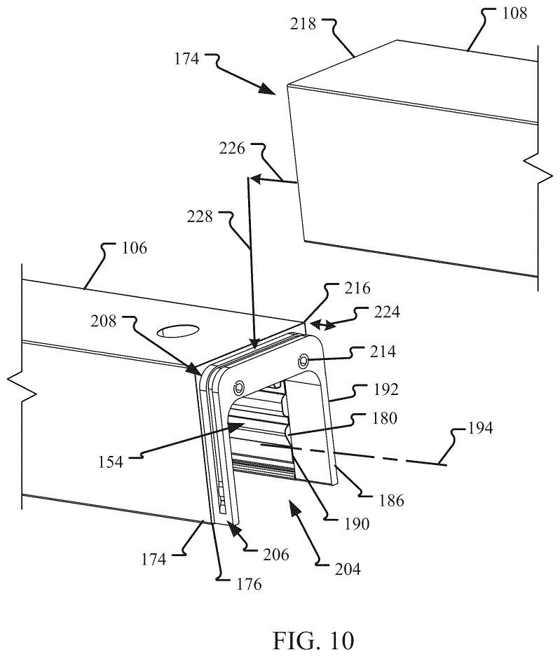

FIGS. 7 and 8 are perspective views of a male connector 186 for use with the light fixture 100 (shown in FIG. 1). The male connector 186 includes a U-shaped body 188 that corresponds to the inner perimeter profile of the body 140 of the housing 102 (shown in FIGS. 5 and 6). The body 188 includes a first end 190 and an opposite second end 192 defining a longitudinal axis 194. Extending between the first and second end 190, 192, the body 188 includes a top member 196 with two side members 198, 200 extending therefrom.

The body 188 defines an inner surface 202 defining an interior chamber 204 and an outer surface 206. The inner surface 202 may be substantially planar. The outer surface 206 includes a first groove 208 and a second groove 210 defined therein. The grooves 208, 210 are parallel to the ends 190, 192 of the body 188 and extend orthogonal relative to the longitudinal axis 194. The first groove 208 is disposed proximate the first end 190 and is spaced apart from the second groove 210 disposed proximate the second end 192 along the longitudinal axis 194. The grooves 208, 210 extend along all three sides of the outer surface 206 of the body 188 and along the top member 196 and the two side members 198, 200 around the outer perimeter of the body 188. In an aspect, the grooves 208, 210 are symmetrical relative to the longitudinal axis 194 relative to a midpoint of the body 188.

The grooves 208, 210 are configured to receive a corresponding rib of the female connector when the male connector 186 is engaged thereto. One or both of the ends of the grooves 208, 210 include a detent 212. The detents 212 are disposed on opposing side members 198, 200 of the U-shaped body 188. In the example, the detent 212 includes an initial ramp surface and an adjacent protrusion. The detent 212 is configured to engage with the corresponding detent feature on the female connector to snap fit the male connector 186 to the female connector when the male connector 186 is received therein. In other examples, the outer surface 206 of the body 188 may include ribs instead of the grooves. In another example, the outer surface 206 of the body 188 may include a combination of ribs and grooves as required or desired. In still further examples, the male connector 186 may be integrally formed at the end of the extruded housing, and for example, an axial cutout formed on the outer surface with one or more grooves or ribs.

In the example, the male connector 186 also includes at least one spring pin 214. The spring pin 214 extends from one end of the body 188 along the direction of the longitudinal axis 194. The spring pin 214 is disposed on the top member 196 and is configured to engage with the inner arm extensions 162a of the housing 102 (shown in FIGS. 5-6) so as to change the end of the housing 102 from a female connector to a male connector.

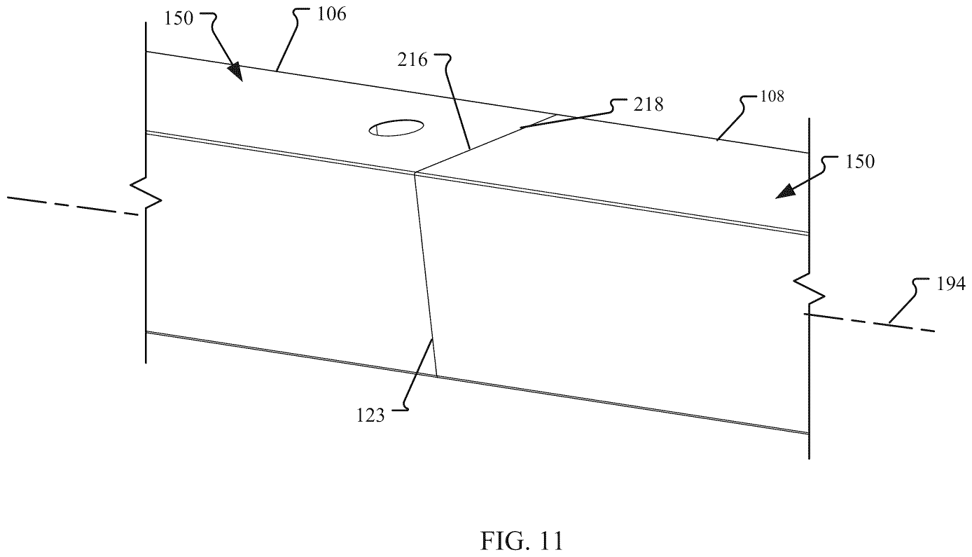

FIGS. 9-11 are perspective views of first and second housings 106, 108 being coupled together via the male connector 186. In the example, the elongate body 140 of each of the housings 106, 108 includes opposing first and second ends. Both of the first and second ends may be formed with the female connector 174 defined therein. Accordingly, the discrete male connector 186 is used to facilitate coupling a second end 216 of the first housing 106 to a first end 218 of the second housing 108. By forming the female connector 174 at both ends of the housing 106, 108, the modularity of the light fixture system is increased, and the installer can selectively convert required or desired ends of the housing to a male connector end via the male connector 186. Additionally, by using a discrete male connector 186, manufacturing efficiencies are facilitated because each end of the housing is formed with the female connector.

Starting first with FIG. 9, FIG. 9 illustrates the first and second housing 106, 108 and the male connector 186 in a disassembled configuration. In the disassembled configuration, the second end 216 of the first housing 106 and the first end 218 of the second housing 108 have female connectors 174 that are free to receive the male connector 186. In the example, the second end 216 of the first housing 106 will receive the male connector 186 because the spring pins 214 are facing away from the second end 216 of the first housing 106. This positioning enables the rib 182 of the female connector 174 to be axially aligned 220 along the longitudinal axis 194 of the male connector 186 and towards the groove 210. In the example, the female connector 174 is disposed completely above the male connector 186. Then the first housing 106 and male connector 186 are transversely positioned 222 in an orthogonal direction relative to each other so as to slidingly engage the rib 182 with the groove 210 in the transverse direction.

The corresponding detents 184, 212 are configured to engage with one another and facilitate coupling the male connector 186 at least partially within the female connector 174 of the first housing 106. In an aspect, the detents 184, 212 may provide feedback (e.g., an audible snap) to indicate when the detents are engaged. Once the female connector 174 is coaxial with the male connector 186, the spring pins 214 can be pushed in the longitudinal direction into engagement with the inner arm extensions 162a of the second end 216 of the first housing 106. Use of the spring pins 214 further engages and fixes the male connector 186 within the female connector 174 and so that the male connector 186 is not easily disengaged from the female connector 174 without disengaging the spring pins 214.

Turning now to FIG. 10, the male connector 186 is coupled to the second end 216 of the first housing 106 such that the second end 216 is a male coupling and the male connector 186 extends from the second end 216. The other groove 208 of the male connector 186 is accessible and configured to couple to the female connector 174 of the second housing 108. The spring pins 214 no longer project from the end face of the male connector 186 so that the female connector 174 can slidingly engage therewith. In the example, the spring pins 214 do not engage with the second housing 108 The outer surface 206 of the male connector 186 corresponds in shape to the inner perimeter profile of the female connector 174 so that the male connector 186 is at least partially received by the radial cutout 176 of the female connector 174 and the outer surface 206 overlaps and is directly adjacent the inner surface 152 (shown in FIGS. 5 and 6) of the first housing 106.

The end 190 of the male connector 186 faces the axial wall 180 of the second end 216 of the first housing 106 so that the inner features of the housing 106 are accessible for the light system components. Additionally, the interior chamber 204 of the male connector 186 axially aligns with the interior cavity 154 of the first housing 106 so that the light system components can extend at least partially through or entirely through the male connector 186 as required or desired.

The end 192 of the male connector 186 axially extends from the second end 216 of the first housing 106. In an example, the groove 208 has an axial width extending along the longitudinal axis 194 and the end 192 has an axial extension distance 224 from the second end 216 that is at least three times greater than the axial width of the groove 208. This extension length of the male connector 186 may facilitate increasing connection strength with the second housing 108. In other examples, two or more corresponding ribs/grooves may be provided for each male-to-female coupling. Additionally, or alternatively, multiple detent locations along the sidewalls/side members may be included so as to increase connection strength.

Once the second end 216 of the first housing 106 includes the male connector 186, the first end of the 218 of the second housing 108 can be coupled to the first housing 106 via its own female connector 174. The female connector 174 of the second housing 108 is axially aligned 226 along the longitudinal axis 194 of the male connector 186 and towards the exposed groove 208. In the example, the female connector 174 is disposed completely above the male connector 186. Then the second housing 108 is transversely positioned 228 in an orthogonal direction relative to the male connector 186 so as to slidingly engage the rib 182 (shown in FIGS. 5 and 6) with the groove 208 in the transverse direction and the corresponding detents engaging.

FIG. 11 illustrates the second end 216 of the first housing 106 coupled to the first end 218 of the second housing 108 at the joint 123 and via the male connector 186 (shown in FIGS. 9 and 10). When the first housing 106 is coupled to the second housing 108 both housings extend along the longitudinal axis 194 of the male connector 186. In examples, where the first housing 106 and/or the second housing 108 have a curvature relative to the longitudinal axis 194, the male connector 186 still enables the ends 216, 218 to be coupled together as the male connector 186 is relatively short in the axial direction while still providing structural strength. In the example, the joint 123 facilitates the outer surface 150 of the first and second housings 106, 108 to be aligned and with the male connector 186 not visible.

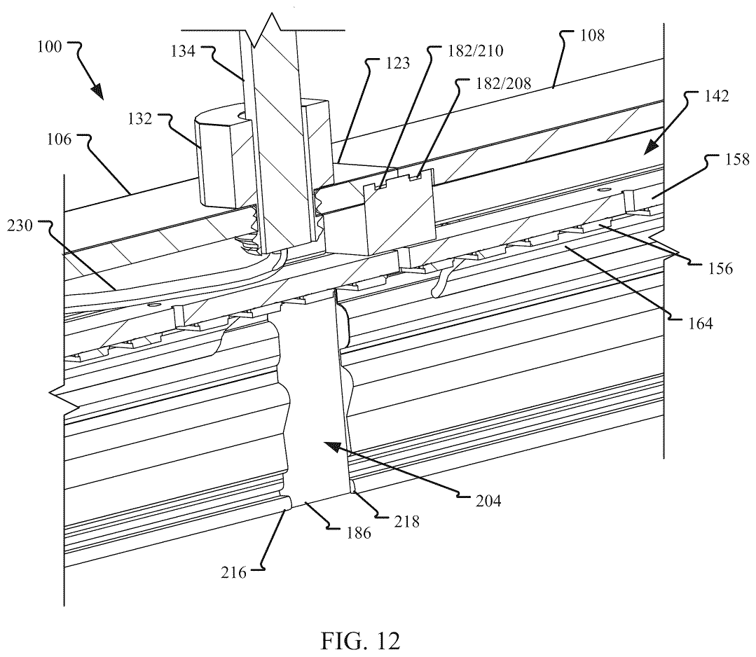

FIG. 12 is a partial, perspective, longitudinal cross-section view of the light fixture 100. The lens cover 166 (shown in FIG. 4) is removed for clarity. The male connector 186 is coupled between the second end 216 of the first housing 106 and the first end 218 of the second housing 108. The joint 123 is disposed at a longitudinal midpoint of the male connector 186 and between the first and second grooves 208, 210. As illustrated in FIG. 12, the rib 182 of the first housing 106 is received within the groove 210 and the rib 182 of the second housing 108 is received within the groove 208. The male connector 186 also extends completely around the inner surface of the joint 123. By surrounding the entire inner surface of each housing 106, 108 at the joint 123, the male connector 186 also blocks light from going through the joint 123 and which is undesirable. Further, because of the rib/groove engagement features, light is further reduced from shining through the joint 123.

The interior chamber 204 of the male connector 186 facilitates allowing the light system 142 to extend therethrough and light to be emitted closer and even through the bottom of the joint 123. As such, the LEDs 156 can be at least partially disposed within the male connector 186 and the LED substrate 158 can at least partially extend within the male connector 186. Also illustrated in FIG. 12, is the LED cover 164, the coupling 132, and the multi conductor cable 134 of the pendent assembly. Additionally, electrical wiring 230 is shown.

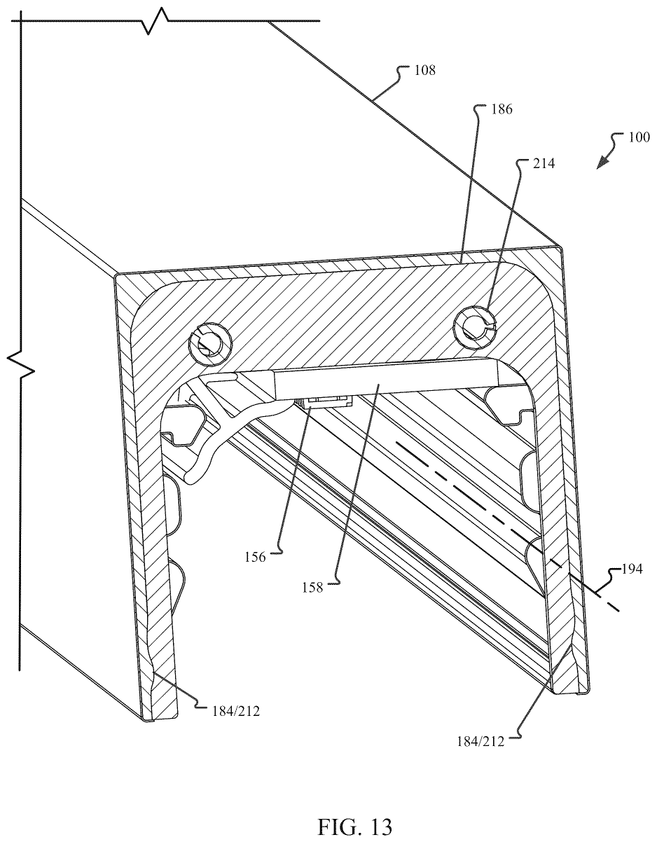

FIG. 13 is a partial, perspective, transverse cross-section view of the light fixture 100. The lens cover 166 (shown in FIG. 4) is removed for clarity. The male connector 186 is coupled to the second housing 108. In this cross-sectional plane, which is orthogonal to the longitudinal axis 194, the detent 184 of the housing 108 and the detent 212 of the male connector 186 are engaged and disposed proximate the bottom of the housing 108 and the male connector 186. The detents 184, 212 are disposed on both sidewalls/side members. In other examples, more than one detent may be disposed on both sidewalls/side members as required or desired. In the example, each detent has a ramp surface to facilitate sliding engagement with one another and then a corresponding protrusion or cavity to promote engagement. It is appreciated that other detent geometry is contemplated herein.

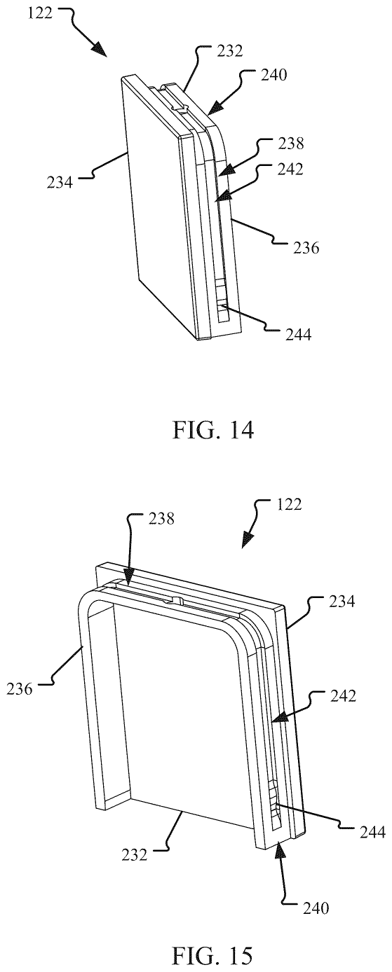

FIGS. 14-15 are perspective views of the end cap 122 of the light fixture 100 (shown in FIG. 1). The end cap 122 has a body 232 including a first end 234 and a second end 236. The first end 234 of the body 232 is shaped and sized to align with the outer surface 150 of the housing 102 (both shown in FIG. 4) so as to at least partially define the architectural shape of the light fixture 100. In the example, the first end 234 is substantially square in shape with a planar outer surface. The second end 236 of the body 232 forms a second male connector 238 configured to couple to the female connector 174 (shown in FIGS. 5-6) of the housing 102. In the example, the second male connector 238 is disposed radially inside the outer perimeter profile of the first end 234.

The second male connector 238 has an outer surface 240 defining a groove 242. The groove 242 is parallel to the ends 234, 236 of the body 232 and extends orthogonal relative to the longitudinal axis. The groove 242 extends along all three sides of the outer surface 240 of the body 232. Similar to the male connector 186 (shown in FIGS. 7 and 8), the groove 242 is configured to receive a corresponding rib of the female connector when the second male connector 238 is engaged thereto. One or both of the ends of the groove 242 include a detent 244 configured to engage with the corresponding detent feature on the female connector to snap fit the second male connector 238 to the female connector when the second male connector 238 is received therein. In other examples, the outer surface 240 of the body 232 may include ribs instead of the grooves.

By forming the end cap 122 with a male connector, the modularity of the light fixture 100 as described above is further facilitated. The end cap 122 can be coupled to either end of the housing and with the female connector such that in combination with the discrete male connector, any number of housings can form an architectural lighting shape and/or pattern as required or desired.

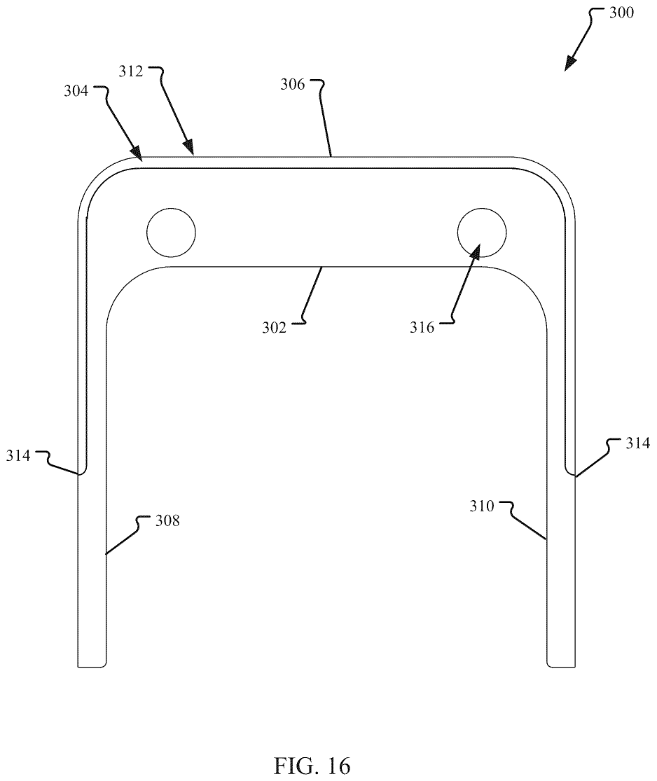

FIG. 16 is an end view of another exemplary male connector 300 for use with the light fixture 100 (shown in FIG. 1). In examples, the light fixture 100 may be flush mount to a supporting surface (e.g., a ceiling). With a flush mount system, the top of the housing is positioned at or near the supporting surface. Accordingly, there may not be enough space for the housing with the female connector to be axially positioned completely above the housing with the male connector and for the two housings to then slidingly engage in the transverse direction.

In this example, the male connector 300 has its first end 302 that includes an axial recess 304 that is disposed along a top member 306 and partially along side members 308, 310. The axial recess 304 is in communication with a first groove 312 such that a portion of the rib of the female connector can axially slide along the longitudinal axis through the axial recess 304 and into the first groove 312 prior to transversely sliding fully into the first groove 312. As such, the first end 302 has a reduced outer profile section that facilitates the female connector axially sliding into the first end 302 of the male connector 300. This configuration of the male connector 300 enables for the female connector to at least partially overlap the male connector 300 when axially aligning to the first groove 312 and prior to transversely engaging. In an aspect, only the first end 302 of the male connector 300 includes the axial recess 304. In another aspect, both the first end 302 and the opposite second end (not shown) includes the axial recess 304.

Distal ends 314 of the axial recess 304 are disposed above and offset from the detents within the first groove 312. In the example, the distal ends 314 may be disposed around the midpoint of the side members 308, 310. In other examples, the axial recess 304 may only be formed along the side members 308, 310 and the top member 306 does not include the axial recess 304. This configuration may increase the pull-down strength resistance of the male connector 300. The male connector 300 also includes apertures 316 for the spring pins (not shown).

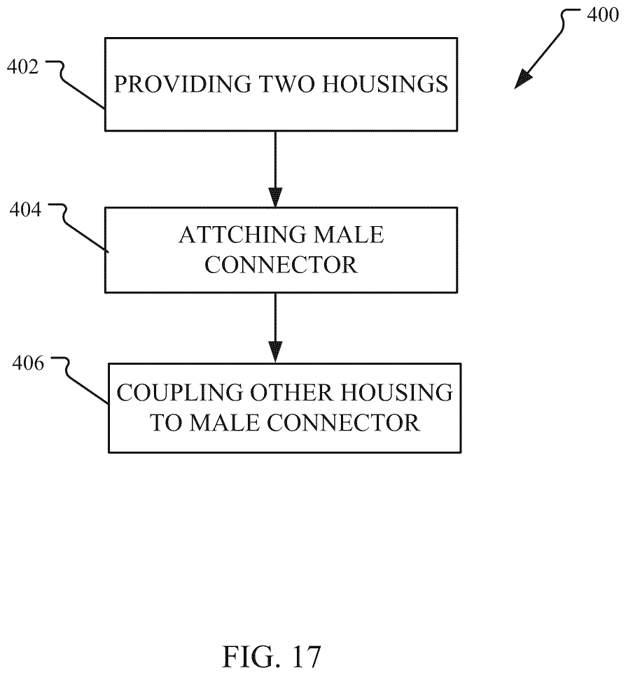

FIG. 17 is a flowchart illustrating an exemplary method 400 of installing a light fixture. The example methods and operations can be implemented or performed by the systems described herein (e.g., the light fixture 100 and components shown in FIGS. 1-16). The method 400 begins with providing two or more housings configured to support a light source (operation 402). In the example, a first housing and a second housing of the two or more housings each having a first end and a second end, the first end and the second end defining a female connector having an inner surface including at least one rib substantially parallel to the first end and the second end.

A male connector is attached to the second end of the first housing (operation 404). In the example, the male connector has a body corresponding in shape to an inner perimeter profile of the two or more housings with a first end and an opposite second end defining a longitudinal axis, the first end and the second end of the body symmetrical relative to the longitudinal axis and the first end and the second end of the body having an outer surface defining at least one groove extending orthogonal to the longitudinal axis. When the first end of the body is received by the second end of the first housing, the at least one rib of the second end of the first housing slidingly engages at least partially within the at least one groove of the first end of the body such that the outer surface of the first end of the body overlaps and is directly adjacent the inner surface of the second end of the first housing. In an aspect, the sliding engagement between the rib and the groove is in an orthogonal transverse direction relative to the longitudinal axis.

In an aspect, the male connector may be coupled to the first housing at a factory and prior to being shipped out to an installation site. In another aspect, the male connector may be coupled to the first housing at the installation site as required or desired.

The first end of the second housing can then be coupled to the male connector (operation 406). The first housing and the second housing abut each other at a joint. When the second end of the body is received by the first end of the second housing, the at least one rib of the first end of the second housing slidingly engages at least at least partially within the at least one groove of the second end of the body such that the outer surface of the second end of the body overlaps and is directly adjacent the inner surface of the first end of the second housing. In an aspect, the sliding engagement between the rib and the groove is in an orthogonal transverse direction relative to the longitudinal axis.

In an example, the male connector is secured to the second end of the first housing via engaging at least one spring pin with an inner extrusion profile feature of the first housing. This further fixes the male connector to the first housing. In another example, coupling the first end of the second housing to the male connector may include axially sliding the first end of the second housing at least partially into the male connector. This axial sliding movement is facilitated by an axial recess so that the housings can at least partially radially overlap along the longitudinal axis when being coupled to each other.

The light fixture described herein facilitates a connection system with a male connector that overlaps each of the housings at the connection joint. This overlap reduces or prevents light from escaping the connection joint. The male/female connectors described herein also increase connection joint strength. Additionally, the male connector and a corresponding end cap forms a modular connection system that enables the housings to be used in a wide variety of architectural lighting configuration and styles. The male connector also enables installation of the light system with simple sliding movement and without a lot of discrete components such as screws, biscuits, etc.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A light fixture comprising:
a first housing configured to support a first light source and having a first end;
a second housing configured to support a second light source and having a second end;
a male connector extending from one of the first or second end and corresponding in shape to an inner perimeter profile of the one of the first or second end of the first or second housing, the male connector having an outer surface defining at least one groove or rib substantially parallel to the one of the first or second end; and
a female connector defined in the other of the first or second end, the female connector having an inner surface defining the other of the at least one groove or rib substantially parallel to the other of the first or second end, wherein when the male connector is received by the female connector, the at least one rib slidingly engages at least partially within the at least one groove such that the outer surface of the male connector overlaps and is directly adjacent the inner surface of the female connector coupling the first end of the first housing to the second end of the second housing.

2. The light fixture of claim 1, wherein the at least one groove and the at least one rib include corresponding detents.

3. The light fixture of claim 2, wherein the male connector has a substantially U-shaped body, the at least one groove or rib disposed on all three sides of the outer surface of the substantially U-shaped body.

4. The light fixture of claim 3, wherein the detents are disposed on opposing side members of the substantially U-shaped body.

5. The light fixture of claim 1, wherein the male connector defines a longitudinal axis, the female connector transversely slidable relative to the longitudinal axis to engage the male connector.

6. The light fixture of claim 1, wherein the male connector defines a longitudinal axis, the male connector axially extending from the one of the first or second end of the first or second housing a distance that is at least three times greater than an axial width of the at least one groove or rib.

7. The light fixture of claim 1, wherein the male connector includes the at least one groove disposed proximate an end of the male connector, the end of the male connector including a reduced outer profile section configured to allow a portion of the at least one rib of the female connector to axially slide relative to the end of the male connector so as to at least partially receive the at least one rib within the at least one groove.

8. The light fixture of claim 1, wherein the male connector is a discrete component and is coupled to the first or second end of the first or second housing.

9. A light fixture comprising:
two or more housings configured to support a light source, a first housing and a second housing of the two or more housings each having a first end and a second end, the first end and the second end defining a female connector having an inner surface including at least one rib substantially parallel to the first end and the second end; and
at least one male connector having a body corresponding in shape to an inner perimeter profile of the two or more housings with a first end and an opposite second end defining a longitudinal axis, the first end and the second end of the body symmetrical relative to the longitudinal axis and the first end and the second end of the body having an outer surface defining at least one groove extending orthogonal to the longitudinal axis,
wherein the at least one male connector is configured to couple the first housing and the second housing together along the longitudinal axis such that an outer perimeter profile of the two or more housings align, and wherein when the first end of the body is received by the second end of the first housing, the at least one rib of the second end of the first housing slidingly engages at least partially within the at least one groove of the first end of the body such that the outer surface of the first end of the body overlaps and is directly adjacent the inner surface of the second end of the first housing, and when the second end of the body is received by the first end of the second housing, the at least one rib of the first end of the second housing slidingly engages at least at least partially within the at least one groove of the second end of the body such that the outer surface of the second end of the body overlaps and is directly adjacent the inner surface of the first end of the second housing.

10. The light fixture of claim 9, wherein the at least one groove and the at least one rib include corresponding detents.

11. The light fixture of claim 9, wherein the at least one male connector includes at least one spring pin extending from the first end of the body, the at least one spring pin engaging an inner extrusion profile feature of the first housing.

12. The light fixture of claim 11, wherein the at least one spring pin does not engage with the second housing.

13. The light fixture of claim 9, further comprising an end cap, the end cap including a second male connector having an outer surface defining at least one groove extending orthogonal to the longitudinal axis, wherein when the second male connector is received by the first end of the first housing, the at least one rib of the first end of the first housing slidingly engages at least partially within the at least one groove of the second male connector such that the outer surface of the second male connector overlaps and is directly adjacent the inner surface of the first end of the first housing.

14. The light fixture of claim 9, wherein at least one of the first end or second end of the body includes an axial recess disposed partially around the outer surface, the axial recess in communication with the at least one groove such that at least a portion of the at least one rib of the female connector is configured to axially slide along the longitudinal axis through the axial recess when being received within the at least one groove.

15. The light fixture of claim 9, wherein the second end of the first housing and the first end of the second housing abut each other at a joint disposed at a longitudinal midpoint of the at least one male connector, the male at least one connector extending completely around the joint at the inner surface.

16. The light fixture of claim 9, further comprising a substrate having the light source, wherein the substrate is disposed within the first housing and elongated along the longitudinal axis, the substrate extending at least partially within the at least one male connector.

17. A method of installing a light fixture, the method comprising:
providing two or more housings configured to support a light source, a first housing and a second housing of the two or more housings each having a first end and a second end, the first end and the second end defining a female connector having an inner surface including at least one rib substantially parallel to the first end and the second end;
attaching a male connector to the second end of the first housing, the male connector having a body corresponding in shape to an inner perimeter profile of the two or more housings with a first end and an opposite second end defining a longitudinal axis, the first end and the second end of the body symmetrical relative to the longitudinal axis and the first end and the second end of the body having an outer surface defining at least one groove extending orthogonal to the longitudinal axis, wherein when the first end of the body is received by the second end of the first housing, the at least one rib of the second end of the first housing slidingly engages at least partially within the at least one groove of the first end of the body such that the outer surface of the first end of the body overlaps and is directly adjacent the inner surface of the second end of the first housing; and
coupling the first end of the second housing to the male connector such that the first housing and the second housing abut each other at a joint, wherein when the second end of the body is received by the first end of the second housing, the at least one rib of the first end of the second housing slidingly engages at least at least partially within the at least one groove of the second end of the body such that the outer surface of the second end of the body overlaps and is directly adjacent the inner surface of the first end of the second housing.

18. The method of claim 17, further comprising securing the male connector to the second end of the first housing via engaging at least one spring pin with an inner extrusion profile feature of the first housing.

19. The method of claim 17, wherein the sliding engagement of the first housing and the second housing occurs in an orthogonal transverse direction relative to the longitudinal axis.

20. The method of claim 17, wherein coupling the first end of the second housing to the male connector includes axially sliding the first end of the second housing at least partially into the male connector.
